(19) United States
(12) Patent Application Publication
(10) Pub. No.: US 2019/0053157 A1
(43) Pub. Date: Feb. 14, 2019

(54) NB-IoT UE Differentiation

(71) Applicant: MediaTek Inc., Hsinchu City (TW)

(72) Inventors: Shiang-Jiun Lin, Hsinchu City (TW); Per Johan Mikael Johansson, Kungsangen (SE); Li-Chuan Tseng, Hsinchu City (TW); Gilles Charbit, Hampshire (GB)

(21) Appl. No.: 16/059,273

(22) Filed: Aug. 9, 2018

Related U.S. Application Data
(60) Provisional application No. 62/544,106, filed on Aug. 11, 2017.

(51) Int. Cl. H04W 52/02; H04W 72/04

(52) U.S. Cl. CPC H04W 52/0216; H04W 52/0241; H04W 72/048

(57) ABSTRACT

Various examples and schemes pertaining to differentiation of user equipment (UE) in narrowband IoT (NB-IoT) are described. A processor of a UE generates a signal containing UE-specific information that is specific to the UE. The processor transmits the signal to a network node of a wireless network. The processor then receives a response from the network node, the response comprising an access stratum (AS) configuration created by the network node based on the UE-specific information. The processor also applies the AS configuration which reduces power consumption of the UE.

### CROSS REFERENCE TO RELATED PATENT APPLICATION(S)

The present disclosure is part of a non-provisional application claiming the priority benefit of U.S. Patent Application No. 62/544,106, filed on 11 Aug. 2017, the content of which is incorporated by reference in its entirety.

### TECHNICAL FIELD

The present disclosure is generally related to Internet of Things (IoT) and, more particularly, to differentiation of user equipment (UE) in narrowband IoT (NB-IoT) for minimizing power consumption of UE.

### BACKGROUND

Unless otherwise indicated herein, approaches described in this section are not prior art to the claims listed below and are not admitted as prior art by inclusion in this section.

NB-IoT is a low-power wide area network radio technology standard developed by the 3^{rd} Generation Partnership Project (3GPP) to enable a wide range of cellular devices, or UEs, and services. To support NB-IoT with a wide range of applications in an efficient manner, it would be beneficial if additional UE-specific information could be provided by a UE to a network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure proposes a number of schemes, techniques, methods and apparatus pertaining to provision of UE-specific information by a UE to a network. With the UE-specific information, the network would be able to provide an application-specific access stratum (AS) configuration, which may impact power consumption of the UE significantly. That is, with AS configuration tailored to the UE according to the UE-specific information, power preservation in the UE may be significantly improved.

In one aspect, a method may involve a processor of a user equipment (UE) generating a signal containing UE-specific information that is specific to the UE and transmitting the signal to a network node of a wireless network. The method may also involve the processor receiving a response from the network node, with the response comprising an access stratum (AS) configuration created by the network node based on the UE-specific information. The method may further involve the processor applying the AS configuration which reduces power consumption of the UE.

In one aspect, a method may involve a processor of a network node of a wireless network transmitting a request to a UE to request for UE-specific information that is specific to the UE. The method may also involve the processor receiving a report from the UE comprising the UE-specific information. The method may further involve the processor generating a response comprising an access stratum (AS) configuration based on the UE-specific information. The method may additionally involve the processor transmitting the response to the UE.

It is noteworthy that, although description provided herein may be in the context of certain radio access technologies, networks and network topologies such as IoT and NB-IoT, the proposed concepts, schemes and any variation(s)/derivative(s) thereof may be implemented in, for and by other types of radio access technologies, networks and network topologies such as, for example and without limitation, 5th Generation, New Radio (NR), Long-Term Evolution (LTE), LTE-Advanced, LTE-Advanced Pro. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a block diagram of an example communication environment in accordance with an implementation of the present disclosure.

FIG. 3 is a flowchart of an example process in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sounding reference signal design with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

Communication pattern (CP) parameters are specific for a given UE or a group of UEs. Sets of CP parameters are typically provided by a Service Capability Exposure Function (SCEF) to a home subscriber server (HSS) which distributes the CP parameters to corresponding mobility management entity (MME) with relevant subscriber data. The MME may use the CP parameters to derive core network (CN) assistance information which is sent to a base station (e.g., eNB or gNB). The MME may also use the CP parameters in selecting CN-assisted base station parameters to provide to the base station during setup of S1 signaling connection (e.g., attach, service request and the like). However, how the MME utilizes the CP parameters and selects CN-assisted data is implementation specific and is not specified in the 3GPP specification. Moreover, CN-assisted base station parameters are not one-to-one mapped from the CP parameters received from HSS. In many cases, the base station would require information with a finer granularity and perhaps on a level that is not known in CN nodes or known based on subscription information. For example, information such as traffic parameters on byte level and traffic block (TB)-size level as well as timing based on subframe level or frame level, which is UE-specific, is not known to the network.

Accordingly, the present disclosure proposes specific UE-differentiation information for NB-IoT. In the context of IoT, there may be a wide range of traffic types and profiles depending on the application. For instance, for a water meter as a UE, the water meter may report or transmit a meter reading (e.g., of a size of 200 bytes) on a daily basis, which means one transmission to the network a day. On the other hand, for a wearable device as a UE, the wearable device may periodically or otherwise frequently transmit user-related information to a network although each transmission may involve a packet of a small size. Accordingly, it would be beneficial to make the network aware of the traffic type and/or traffic profile specific to a given UE so that the network may configure radio resources more precisely with respect to the UE, thereby helping the UE minimize or otherwise reduce power consumption.

Under various proposed schemes in accordance with the present disclosure, a UE may report UE-specific information to a network. The UE-specific information may represent or otherwise indicate preference of the UE with respect to one or more aspects of the UE. For instance, the UE-specific information may include at least a UE-desired value for a radio resource control (RRC) inactivity timer, and the UE-specific information on the value of RRC inactivity timer may be in an RRC format or any other format that is understandable by the network node. Alternatively, or additionally, the UE-specific information may include one or more parameters of discontinuous reception (DRX) in a connected mode, and the UE-specific information on the value of RRC inactivity timer may be in an RRC format or any other format that is understandable by the network node. Under the proposed schemes, the UE may report the UE-specific information to the network when the UE receives a request for the UE-specific information from a base station (e.g., eNB or gNB) of the network.

Under various proposed schemes in accordance with the present disclosure, upon receiving UE-specific information form a UE, a network may handle the UE-specific information accordingly. For instance, a base station (e.g., eNB or gNB) of the network may request the UE to report the UE-specific information by sending a request for the UE-specific information. The base station may store the received UE-specific information in an MME. The base station may also retrieve the UE-specific information from the MME upon receiving an RRC connection request or an RRC connection resume request from the UE. In response, the MME may provide the UE-specific information to the base station upon receiving a request for the UE-specific information from the base station. Moreover, under the various proposed schemes, the base station may compose, construct, create or otherwise formulate an application-specific AS configuration based on the UE-specific information reported by the UE. Additionally, based on the UE-specific information, the base station may apply the AS configuration at the base station side. The UE may receive the AS configuration based on the UE-specific information and may apply the AS configuration at the UE side.

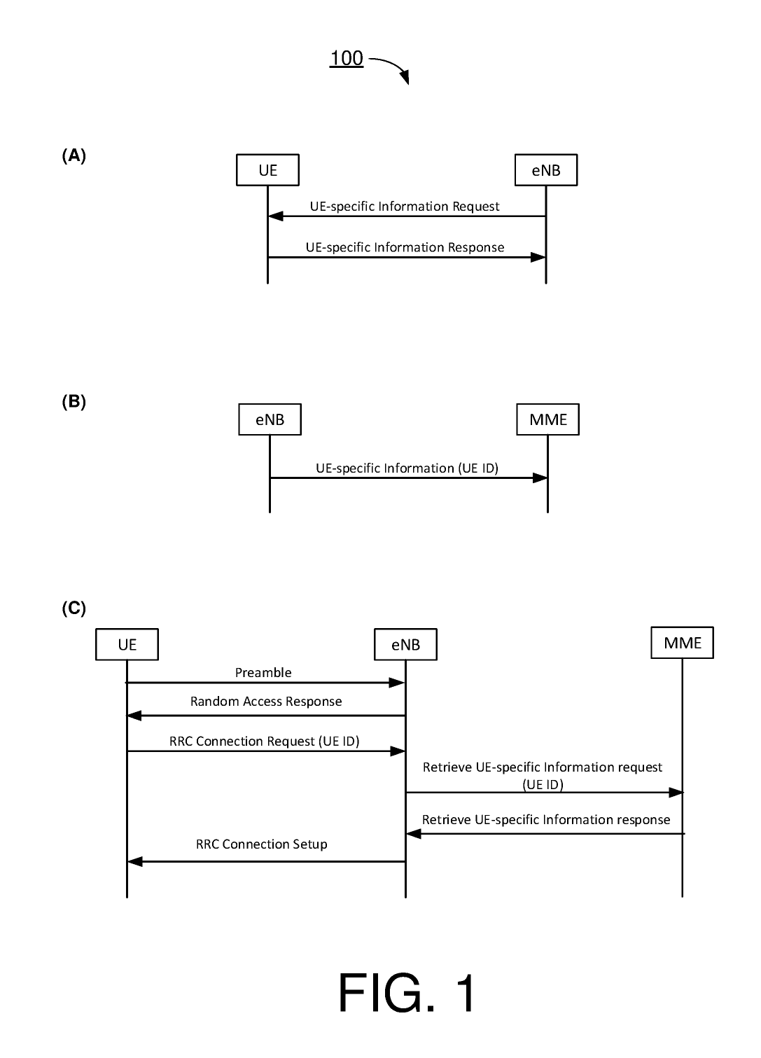

FIG. 1 illustrates an example scenario 100 in accordance with an implementation of the present disclosure. As shown in part (A) of FIG. 1, a network node (represented by an eNB in FIG. 1) of a wireless network may transmit, to a UE, a request for UE-specific information including the identity of the UE (UE ID). In response, the UE may transmit, to the network node, a response including UE-specific information to the network node. As shown in part (B) of FIG. 1, the network node may transmit, to an MME, the UE-specific information to store the UE-specific information at the MME. As shown in part (C) of FIG. 1, at a later time, when the UE connects to the same or a different network node (represented by an eNB in FIG. 1), the UE may transmit a preamble to the network node. The network node may transmit a random access response to the UE. Under the proposed schemes of the present disclosure, the UE may then transit, to the network node, an RRC connection request including the identity of the UE. Upon receiving the RRC connection request, the network node may retrieve UE-specific information associated with the UE by transmitting, to the MME, a request for the UE-specific information. The request may identify the UE by including the UE ID of the UE. In response, the MME may transmit, to the network node, a response including the UE-specific information for the UE that is stored at the MME. The network node may compose, construct, create or otherwise formulate an application-specific AS configuration based on the UE-specific information. The network node may then transmit, to the UE, an RRC connection setup message that includes the AS configuration which may be applied by the UE to minimize or otherwise reduce power consumption of the UE.

### Proposed Schemes

Under a first proposed scheme in accordance with the present disclosure, a UE may propose to an MME, through non-access stratum (NAS) signaling, the configuration of a power-saving mode (PSM) and/or an extended DRX (eDRX). Under the first proposed scheme, with respect to a UE utilizing PSM, there may be at least two approaches to keeping the UE reachable after uplink (UL) transmission. In a first approach, the UE may stay in the connected mode for a period of time based on AS behavior, before entering into a sleep state in PSM, by spending a short or no amount of time in an idle mode. In a second approach, the UE may enter into the idle mode immediately and remain in that condition for a period of time before entering into the sleep state in PSM. Thus, in the first approach the UE may be immediately reachable while, in the second approach, the UE may be page-able during the idle mode. In both the first and second approaches, once the UE enters into the sleep state in PSM the UE becomes unreachable. For both the first and second approaches, the NAS and AS configurations may be coordinated. Advantageously, with NAS and AS configurations coordinated, the UE would not need to stay in idle mode as long as it would need to without coordination and the UE may enter into PSM sooner, thereby minimizing or otherwise reducing power consumption.

Otherwise, without implementing the first proposed scheme, in one situation the UE may stay in the connected mode DRX for a period of time before entering into the idle mode for a while to be reachable by paging. In such case both AS and NAS may be configured to provide the opportunity to the network for downlink (DL) transmission, thereby leading the UE to stay awake excessively long while consuming power unnecessarily on physical downlink control channel (PDCCH) monitoring. In another situation, without implementing the first proposed scheme, both NAS and AS may assume that another layer may handle the DL transmission while such assumption is not correct. Thus, the UE may directly enter into a sleep state in PSM while the UE should wait in a reachable state for a period of time.

To address the above-described issue, under the first proposed scheme, AS configurations may be aligned with traffic requirements of the UE as well as usage of NAS features (e.g., eDRX and PSM mode) on both of (1) transition from connected mode to idle mode and (2) connected mode DRX. Based on its application and traffic pattern, the UE may suggest to the network a desired or preferred configuration with respect to the transition from connected mode to idle mode and the connected mode DRX, so as to help the network determine a power-efficient AS configuration which in turn helps the UE minimize power consumption.

For further reduction in power consumption for NB-IoT, under the first proposed scheme, the UE may also impact the AS configuration for entering into the idle mode. For instance, according to the traffic type and traffic pattern, the UE may suggest to the network a preference of the UE on an RRC inactivity timer as well as connected mode DRX configurations.

Under the first proposed scheme, the UE may report the UE-specific information during an initial registration procedure between the UE and the network. The procedure may be similar to a UE information procedure during which the network requests UE-specific information from the UE in response to which the UE transmits desired RRC inactivity timer and connected mode DRX configurations.

As a user plane (UP) cellular IoT (CIoT) solution, for efficiency in avoiding or otherwise minimizing radio overhead and for solutions without the possibility for reconfiguration (e.g., without AS security), UE-specific AS information may need to be available to the base station of the network at or before message 4 (MSG4), to be part of a first AS configuration message to the UE for a certain access. For connection resumption, the UE-specific AS information may be stored in the UE context that is resumed in the base station.

As a control plane (CP) CIoT solution, for connection establishment (and CIoT CP optimization), the base station may receive the UE-specific AS information from the MME. The UE-specific AS information may be similar to AS UE capabilities. A new S1AP may be needed to store the UE preference information in the MME.

Advantageously, with the UE suggesting to the network its preference on the RRC inactivity timer and the connected mode DRX configurations, the base station may configure the AS configuration on the transition from connected mode to idle mode as well as the connected mode DRX to better align with application traffic requirements of the UE and the usage of NAS features such as eDRX and PSM. Accordingly, the UE may stay in the connected mode DRX properly or turn to idle to be reachable by paging properly for DL data reception, while keeping the UE reachable in a power-efficient way.

Under a second proposed scheme in accordance with the present disclosure, the UE may report traffic profile and power consumption profile to the base station. Once the base station is aware of the traffic profile and power consumption profile of the UE, the base station may utilize such information (e.g., for scheduling, early data transmission, and/or quick RRC connection release) in a way that is beneficial to the UE at least in terms of power preservation. The traffic profile of the UE may include information such as, for example and without limitation, single packet transactions, UL only, UL followed by DL, a typical packet size, and/or one or more semi-persistent scheduling (SPS) settings. The power consumption profile of the UE may include information such as, for example and without limitation, whether the UE is battery powered and a remaining battery life of the UE in an event that the UE is battery powered.

Accordingly, when the UE reports its typical packet size to the base station, the base station may allocate UL grant with proper TB size to accommodate the data packet. Thus, the UE needs not send buffer status report (BSR) for additional negotiation. Advantageously, power preservation for the UE may be improved, especially for the UE in deep coverage which needs more repetition for data transmission.

Moreover, when the UE has periodic UL data and reports its desired UL SPS setting(s), SPS period and SPS UL grant size to the base station, based on the UL traffic pattern, the UE needs not go through a random access channel (RACH) procedure to request UL grant whenever UL data arrives at the UE. Advantageously, message exchange between the UE and the base station may be reduced, thereby improving power preservation for the UE.

Furthermore, when the UE reports its battery-powered status and/or remaining battery life to the base station, the base station may schedule transmission and reception for the UE promptly and turn the UE to idle/PSM/eDRX state to improve power preservation for the UE.

It is noteworthy that, under the various schemes in accordance with the present disclosure, settings of UE-specific information, such as the RRC inactivity timer, the connected mode DRX configurations, the traffic profile, and the power consumption profile, may be set by a subscription associated with one or more applications of the UE, by an AT command through one or more external peripherals, by an application server, by a system provider, and/or by a service provider.

### Illustrative Implementations

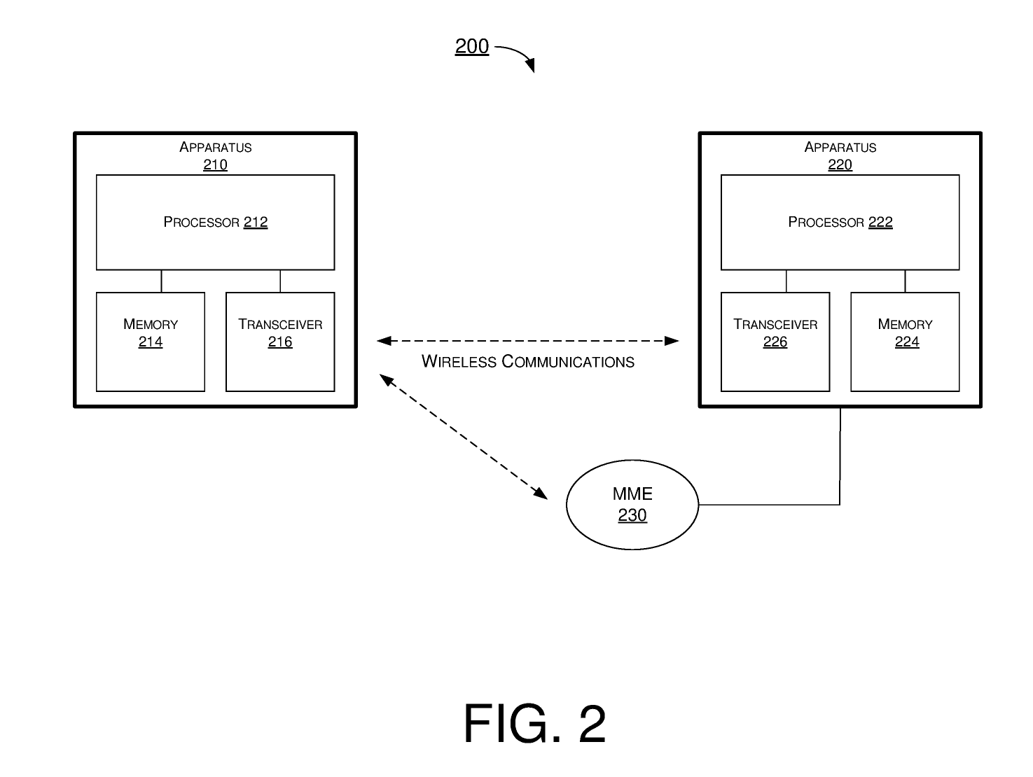

FIG. 2 illustrates an example communication environment 200 having an example apparatus 210 and an example apparatus 220 in accordance with an implementation of the present disclosure. Each of apparatus 210 and apparatus 220 may perform various functions to implement schemes, techniques, processes and methods described herein pertaining to differentiation of UE in NB-IoT for minimizing power consumption of UE, including various schemes described above as well as processes 300 and 400 described below.

Each of apparatus 210 and apparatus 220 may be a part of an electronic apparatus, which may be a user equipment (UE) such as a portable or mobile apparatus, a wearable apparatus, a wireless communication apparatus or a computing apparatus. For instance, each of apparatus 210 and apparatus 220 may be implemented in a smartphone, a smartwatch, a personal digital assistant, a digital camera, or a computing equipment such as a tablet computer, a laptop computer or a notebook computer. Each of apparatus 210 and apparatus 220 may also be a part of a machine type apparatus, which may be an IoT or NB-IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. Alternatively, each of apparatus 210 and apparatus 220 may be implemented in the form of one or more integrated-circuit (IC) chips such as, for example and without limitation, one or more single-core processors, one or more multi-core processors, or one or more complex-instruction-set-computing (CISC) processors. Each of apparatus 210 and apparatus 220 may include at least some of those components shown in FIG. 2 such as a processor 212 and a processor 222, respectively. Each of apparatus 210 and apparatus 220 may further include one or more other components not pertinent to the proposed scheme of the present disclosure (e.g., internal power supply, display device and/or user interface device), and, thus, such component(s) of each of apparatus 210 and apparatus 220 are neither shown in FIG. 2 nor described below in the interest of simplicity and brevity.

In some implementations, at least one of apparatus 210 and apparatus 220 may be a part of an electronic apparatus, which may be a network node such as a transmit/receive point (TRP), a base station, a small cell, a router or a gateway. For instance, at least one of apparatus 210 and apparatus 220 may be implemented in an eNodeB in an LTE, LTE-Advanced or LTE-Advanced Pro network or in a gNB in a 5G, NR, IoT or NB-IoT network. Alternatively, at least one of apparatus 210 and apparatus 220 may be implemented in the form of one or more IC chips such as, for example and without limitation, one or more single-core processors, one or more multi-core processors, or one or more CISC processors.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including differentiation of UE in NB-IoT for minimizing power consumption of UE in accordance with various implementations of the present disclosure.

In some implementations, apparatus 210 may also include a transceiver 216 coupled to processor 212 and capable of wirelessly transmitting and receiving data. In some implementations, apparatus 210 may further include a memory 214 coupled to processor 212 and capable of being accessed by processor 212 and storing data therein. In some implementations, apparatus 220 may also include a transceiver 226 coupled to processor 222 and capable of wirelessly transmitting and receiving data. In some implementations, apparatus 220 may further include a memory 224 coupled to processor 222 and capable of being accessed by processor 222 and storing data therein. Accordingly, apparatus 210 and apparatus 220 may wirelessly communicate with each other via transceiver 216 and transceiver 226, respectively.

To aid better understanding, the following description of the operations, functionalities and capabilities of each of apparatus 210 and apparatus 220 is provided in the context of a mobile communication environment in which apparatus 210 is implemented in or as a wireless communication device, a communication apparatus or a UE and apparatus 220 is implemented in or as a network node (e.g., base station) connected or otherwise communicatively coupled to an MME 230.

In one aspect, processor 212 of apparatus 210 as a UE may generate a signal containing UE-specific information that is specific to apparatus 210. Additionally, processor 212 may transmit, via transceiver 216, the signal to apparatus 220. Moreover, processor 212 may receive, via transceiver 216, a response from apparatus 220, with the response including an AS configuration created by apparatus 220 based on the UE-specific information. Furthermore, processor 212 may apply the AS configuration which reduces power consumption of apparatus 210.

In some implementations, the UE-specific information may include at least a value of an RRC inactivity timer as determined by processor 212. In some implementations, in transmitting the signal, processor 212 may transmit the value of the RRC inactivity timer in an RRC format or any other format that is understandable by apparatus 220.

In some implementations, the UE-specific information may include at least one or more parameters of a DRX configuration in a connected mode as determined by processor 212. In some implementations, in transmitting the signal, processor 212 may transmit the one or more parameters of the DRX configuration in an RRC format or any other format that is understandable by apparatus 220.

In some implementations, the UE-specific information may include at least a traffic profile with respect to uplink and downlink traffic related to apparatus 210. In some implementations, the traffic profile may include information on single packet transactions, a typical packet size, and/or one or more SPS settings.

In some implementations, the UE-specific information may include at least a power consumption profile with respect to power consumption of apparatus 210. In some implementations, the power consumption profile may include information on whether apparatus 210 is battery powered and a remaining battery life of apparatus 210 in an event that apparatus 210 is battery powered.

In some implementations, in generating the signal containing the UE-specific information, processor 212 may determine the UE-specific information based on a traffic type and a traffic pattern with respect to uplink and downlink traffic related to apparatus 210.

In some implementations, in applying the AS configuration, processor 212 may utilize the AS configuration with respect to a PSM, an eDRX configuration, or both, pertaining to either or both of a transition from a connected mode to an idle mode and DRX in the connected mode.

In some implementations, in applying the AS configuration, processor 212 may stay in a connected mode for a period of time based on an AS behavior before entering into a PSM directly from the connected mode.

In some implementations, in applying the AS configuration, processor 212 may enter into an idle mode and staying in the idle mode for a period of time before entering into a PSM.

In some implementations, processor 212 may receive, via transceiver 216, a request for the UE-specific information from apparatus 220. In such cases, the transmitting of the signal may be in response to receiving the request.

In some implementations, processor 212 may receive an input of the UE-specific information from a subscription associated with one or more applications of the UE, an AT command through one or more external peripherals, an application server, a system provider, or a service provider. That is, the UE-specific information may be set by a subscription associated with one or more applications of the UE, an AT command through one or more external peripherals, an application server, a system provider, or a service provider.

In one aspect, processor 222 of processor 220 as a network node of a wireless network may transmit, via transceiver 226, a request to apparatus 210 as a UE to request for UE-specific information that is specific to apparatus 210. Additionally, processor 222 may receive, via transceiver 226, a report from apparatus 210 including the UE-specific information. Moreover, processor 222 may generate a response that includes an AS configuration based on the UE-specific information. Furthermore, processor 222 may transmit, via transceiver 226, the response to apparatus 210.

In some implementations, the UE-specific information may include either or both of a value of an RRC inactivity timer and a parameter of a DRX configuration in a connected mode. In some implementations, at least one of the value of the RRC inactivity timer and the parameter of the DRX configuration may be in an RRC format or any other format that is understandable by apparatus 220.

In some implementations, the UE-specific information may include either or both of a traffic profile with respect to uplink and downlink traffic related to apparatus 210 and a power consumption profile with respect to power consumption of apparatus 210. In some implementations, the traffic profile may include information on single packet transactions, a typical packet size, and/or one or more SPS settings. In some implementations, the power consumption profile may include information on whether apparatus 210 is battery powered and a remaining battery life of apparatus 210 in an event that apparatus 210 is battery powered.

In some implementations, for CP CIoT optimization, processor 222 may store the UE-specific information in MME 230. Moreover, processor 222 may receive, via transceiver 226, an RRC connection request from apparatus 210. Furthermore, processor 222 may retrieve the UE-specific information from MME 230.

In some implementations, for UP CIoT optimization, processor 222 may store the UE-specific information in memory 224 of apparatus 220. Moreover, processor 222 may receive, via transceiver 226, an RRC connection resume request from apparatus 210. Furthermore, processor 222 may resume an RRC connection with apparatus 210 using the UE-specific information from memory 224.

### Illustrative Processes

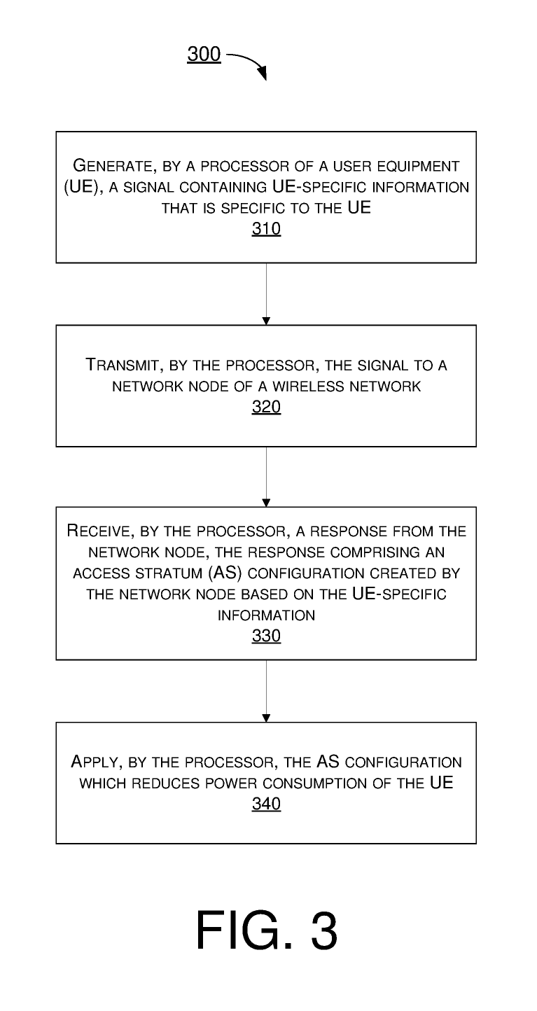

FIG. 3 illustrates an example process 300 in accordance with an implementation of the present disclosure. Process 300 may be an example implementation of the proposed schemes described above with respect to differentiation of UE in NB-IoT for minimizing power consumption of UE in accordance with the present disclosure. Process 300 may represent an aspect of implementation of features of apparatus 210 and apparatus 220. Process 300 may include one or more operations, actions, or functions as illustrated by one or more of blocks 310, 320, 330 and 340. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may also be repeated partially or entirely. Process 300 may be implemented by apparatus 210, apparatus 220 and/or any suitable wireless communication device, UE, base station or machine type devices. Solely for illustrative purposes and without limitation, process 300 is described below in the context of apparatus 210 as a UE and apparatus 220 as a network node (e.g., base station) of a wireless network. Process 300 may begin at block 310.

At 310, process 300 may involve processor 212 of apparatus 210 as a UE generating a signal containing UE-specific information that is specific to apparatus 210. Process 300 may proceed from 310 to 320.

At 320, process 300 may involve processor 212 transmitting, via transceiver 216, the signal to apparatus 220. Process 300 may proceed from 320 to 330.

At 330, process 300 may involve processor 212 receiving, via transceiver 216, a response from apparatus 220, with the response including an AS configuration created by apparatus 220 based on the UE-specific information. Process 300 may proceed from 330 to 340.

At 340, process 300 may involve processor 212 applying the AS configuration which reduces power consumption of apparatus 210.

In some implementations, the UE-specific information may include at least a value of an RRC inactivity timer as determined by processor 212. In some implementations, in transmitting the signal, process 300 may involve processor 212 transmitting the value of the RRC inactivity timer in an RRC format or any other format that is understandable by apparatus 220.

In some implementations, the UE-specific information may include at least one or more parameters of a DRX configuration in a connected mode as determined by processor 212. In some implementations, in transmitting the signal, process 300 may involve processor 212 transmitting the one or more parameters of the DRX configuration in an RRC format or any other format that is understandable by apparatus 220.

In some implementations, the UE-specific information may include at least a traffic profile with respect to uplink and downlink traffic related to apparatus 210. In some implementations, the traffic profile may include information on single packet transactions, a typical packet size, and/or one or more SPS settings.

In some implementations, the UE-specific information may include at least a power consumption profile with respect to power consumption of apparatus 210. In some implementations, the power consumption profile may include information on whether apparatus 210 is battery powered and a remaining battery life of apparatus 210 in an event that apparatus 210 is battery powered.

In some implementations, in generating the signal containing the UE-specific information, process 300 may involve processor 212 determining the UE-specific information based on a traffic type and a traffic pattern with respect to uplink and downlink traffic related to apparatus 210.

In some implementations, in applying the AS configuration, process 300 may involve processor 212 utilizing the AS configuration with respect to a PSM, an eDRX configuration, or both, pertaining to either or both of a transition from a connected mode to an idle mode and DRX in the connected mode.

In some implementations, in applying the AS configuration, process 300 may involve processor 212 staying in a connected mode for a period of time based on an AS behavior before entering into a PSM directly from the connected mode.

In some implementations, in applying the AS configuration, process 300 may involve processor 212 entering into an idle mode and staying in the idle mode for a period of time before entering into a PSM.

In some implementations, process 300 may further involve processor 212 receiving, via transceiver 216, a request for the UE-specific information from apparatus 220. In such cases, the transmitting of the signal may be in response to receiving the request.

In some implementations, process 300 may further involve processor 212 receiving an input of the UE-specific information from a subscription associated with one or more applications of the UE, an AT command through one or more external peripherals, an application server, a system provider, or a service provider.

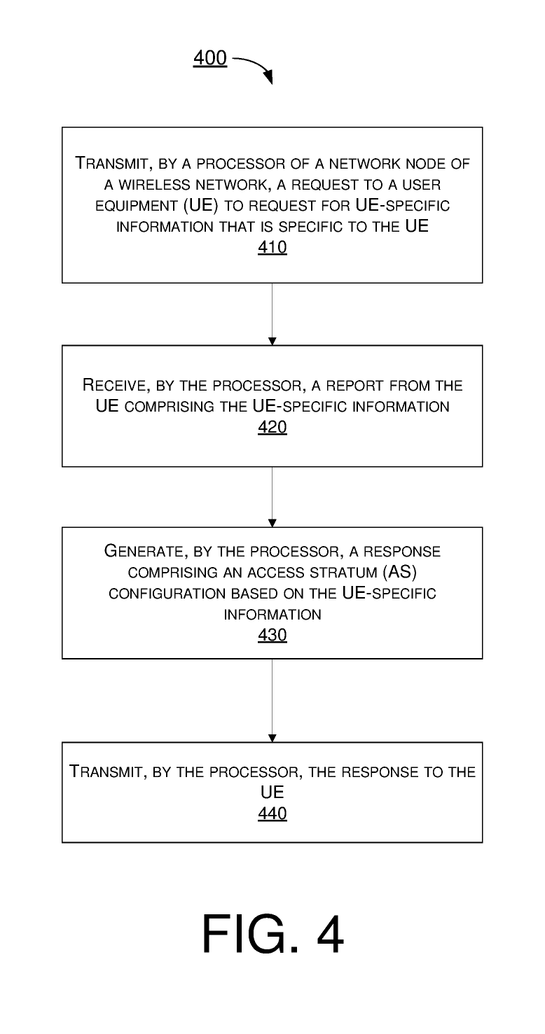

FIG. 4 illustrates an example process 400 in accordance with an implementation of the present disclosure. Process 400 may be an example implementation of the proposed schemes described above with respect to differentiation of UE in NB-IoT for minimizing power consumption of UE in accordance with the present disclosure. Process 400 may represent an aspect of implementation of features of apparatus 210 and apparatus 220. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may also be repeated partially or entirely. Process 400 may be implemented by apparatus 210, apparatus 220 and/or any suitable wireless communication device, UE, base station or machine type devices. Solely for illustrative purposes and without limitation, process 400 is described below in the context of apparatus 210 as a UE and apparatus 220 as a network node (e.g., base station) of a wireless network. Process 400 may begin at block 410.

At 410, process 400 may involve processor 222 of processor 220 as a network node of a wireless network transmitting, via transceiver 226, a request to apparatus 210 as a UE to request for UE-specific information that is specific to apparatus 210. Process 400 may proceed from 410 to 420.

At 420, process 400 may involve processor 222 receiving, via transceiver 226, a report from apparatus 210 including the UE-specific information. Process 400 may proceed from 420 to 430.

At 430, process 400 may involve processor 222 generating a response that includes an AS configuration based on the UE-specific information. Process 400 may proceed from 430 to 440.

At 440, process 400 may involve processor 222 transmitting, via transceiver 226, the response to apparatus 210.

In some implementations, the UE-specific information may include either or both of a value of an RRC inactivity timer and a parameter of a DRX configuration in a connected mode. In some implementations, at least one of the value of the RRC inactivity timer and the parameter of the DRX configuration may be in an RRC format or any other format that is understandable by apparatus 220.

In some implementations, the UE-specific information may include either or both of a traffic profile with respect to uplink and downlink traffic related to apparatus 210 and a power consumption profile with respect to power consumption of apparatus 210. In some implementations, the traffic profile may include information on single packet transactions, a typical packet size, and/or one or more SPS settings. In some implementations, the power consumption profile may include information on whether apparatus 210 is battery powered and a remaining battery life of apparatus 210 in an event that apparatus 210 is battery powered.

In some implementations, for CP CIoT optimization, process 400 may further involve processor 222 storing the UE-specific information in MME 230. Moreover, process 400 may involve processor 222 receiving, via transceiver 226, an RRC connection request from apparatus 210. Furthermore, process 400 may involve processor 222 retrieving the UE-specific information from MME 230.

In some implementations, for UP CIoT optimization, process 400 may further involve processor 222 storing the UE-specific information in memory 224 of apparatus 220. Moreover, process 400 may involve processor 222 receiving, via transceiver 226, an RRC connection resume request from apparatus 210. Furthermore, process 400 may involve processor 222 resuming an RRC connection with apparatus 210 using the UE-specific information from memory 224.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
generating, by a processor of a user equipment (UE), a signal containing UE-specific information that is specific to the UE;
transmitting, by the processor, the signal to a network node of a wireless network;
receiving, by the processor, a response from the network node, the response comprising an access stratum (AS) configuration created by the network node based on the UE-specific information; and
applying, by the processor, the AS configuration which reduces power consumption of the UE.

2. The method of claim 1, wherein the UE-specific information comprises at least a value of a radio resource control (RRC) inactivity timer as determined by the processor.

3. The method of claim 1, wherein the UE-specific information comprises at least one or more parameters of a discontinuous reception (DRX) configuration in a connected mode as determined by the processor.

4. The method of claim 1, wherein the UE-specific information comprises at least a traffic profile with respect to uplink and downlink traffic related to the UE.

5. The method of claim 4, wherein the traffic profile comprises information on single packet transactions, a typical packet size, one or more semi-persistent scheduling (SPS) settings, or a combination thereof.

6. The method of claim 1, wherein the UE-specific information comprises at least a power consumption profile with respect to power consumption of the UE.

7. The method of claim 6, wherein the power consumption profile comprises information on whether the UE is battery powered and a remaining battery life of the UE in an event that the UE is battery powered.

8. The method of claim 1, wherein the generating of the signal containing the UE-specific information comprises determining the UE-specific information based on a traffic type and a traffic pattern with respect to uplink and downlink traffic related to the UE.

9. The method of claim 1, wherein the applying of the AS configuration comprises utilizing the AS configuration with respect to a power-saving mode (PSM), an extended discontinuous reception (eDRX) configuration, or both, pertaining to either or both of a transition from a connected mode to an idle mode and DRX in the connected mode.

10. The method of claim 1, wherein the applying of the AS configuration comprises staying in a connected mode for a period of time based on an AS behavior before entering into a power-saving mode (PSM) directly from the connected mode.

11. The method of claim 1, wherein the applying of the AS configuration comprises entering into an idle mode and staying in the idle mode for a period of time before entering into a power-saving mode (PSM).

12. The method of claim 1, further comprising:
receiving, by the processor, a request for the UE-specific information from the network node,
wherein the transmitting of the signal comprises transmitting the signal responsive to receiving the request.

13. The method of claim 1, further comprising:
receiving, by the processor, an input of the UE-specific information from a subscription associated with one or more applications of the UE, an AT command through one or more external peripherals, an application server, a system provider, or a service provider.

14. A method, comprising:
transmitting, by a processor of a network node of a wireless network, a request to a user equipment (UE) to request for UE-specific information that is specific to the UE;
receiving, by the processor, a report from the UE comprising the UE-specific information;
generating, by the processor, a response comprising an access stratum (AS) configuration based on the UE-specific information; and
transmitting, by the processor, the response to the UE.

15. The method of claim 14, wherein the UE-specific information comprises at least a value of a radio resource control (RRC) inactivity timer.

16. The method of claim 14, wherein the UE-specific information comprises at least one or more parameters of a discontinuous reception (DRX) configuration in a connected mode.

17. The method of claim 14, wherein the UE-specific information comprises either or both of a traffic profile with respect to uplink and downlink traffic related to the UE and a power consumption profile with respect to power consumption of the UE.

18. The method of claim 17, wherein the traffic profile comprises information on single packet transactions, a typical packet size, one or more semi-persistent scheduling (SPS) settings, or a combination thereof.

19. The method of claim 14, further comprising:
storing, by the processor, the UE-specific information in a mobility management entity (MME).
receiving, by the processor, a radio resource control (RRC) connection request from the UE; and
retrieving, by the processor, the UE-specific information from the MME.

20. The method of claim 14, further comprising:
storing, by the processor, the UE-specific information in a memory of the base station.
receiving, by the processor, a radio resource control (RRC) connection resume request from the UE; and
resuming, by the processor, an RRC connection with the UE using the UE-specific information from the memory of the base station.
